(19) United States
(12) Patent Application Publication
(10) Pub. No.: US 2011/0055753 A1
(43) Pub. Date: Mar. 3, 2011

(54) USER INTERFACE METHODS PROVIDING SEARCHING FUNCTIONALITY

(76) Inventors: Samuel J. HORODEZKY, San Diego, CA (US); Kam-Cheong Anthony Tsoi, San Diego, CA (US)

(21) Appl. No.: 12/551,367

(22) Filed: Aug. 31, 2009

(51) Int. Cl. G06F 3/033; G06F 3/048

(52) U.S. Cl. 715/810; 715/863

(57) ABSTRACT

Methods and devices provide an efficient user interface for activating a function by detecting a tickle gesture on a touch surface of a computing device. The tickle gesture may include short strokes in approximately opposite directions traced on a touch surface, such as a touchscreen or touchpad. The activated function may open an application or activate a search function. The index menu item may change based on the location and/or movement of the touch on the touch surface. Such functionality may show search results based on the menu item displayed before the user's finger was lifted from the touch surface.

### FIELD OF THE INVENTION

The present invention relates generally to computer user interface systems and more particularly to user systems providing a search function.

### BACKGROUND

Personal electronic devices (e.g. cell phones, PDAs, laptops, gaming devices) provide users with increasing functionality and data storage. Personal electronic devices serve as personal organizers, storing documents, photographs, videos, and music, as well as serving as portals to the Internet and electronic mail. In order to fit within the small displays of such devices, documents (e.g., music files and contact lists) are typically displayed in a viewer that can be controlled by a scrolling function. In order to view all or parts of a document or parse through a list of digital files, typical user interfaces permit users to scroll up or down by using a scroll bar, using a pointing device function such as a mouse pad or track ball. Another known user interface mechanism for activating the scroll function is a unidirectional vertical swipe movement of one finger on a touchscreen display as implemented on the Blackberry Storm® mobile device. However, such scroll methods for viewing documents and images can be difficult and time consuming, particularly to accomplish quick and accurate access to different parts of a large document or extensive lists. This is particularly the case in small portable computing devices whose usefulness depends upon the scrolling function given their small screen size.

### SUMMARY

The various aspects include methods for providing a user interface gesture function on a computing device including detecting a touch path event on a user interface device, determining whether the touch path event is a tickle gesture, and activating a function associated with the tickle gesture when it is determined that the touch path event is a tickle gesture. Determining whether the touch path event is a tickle gesture may include determining that the touch path event traces an approximately linear path, detecting a reversal in direction of the touch path event, determining a length of the touch path event in each direction, and determining a number of times the direction of the touch path event reverses. Detecting a reversal in the direction of the touch path event may include detecting whether the reversal in the direction of the touch path event is to an approximately opposite direction. The various aspects may also provide a method for providing a user interface gesture function on a computing device, including comparing the length of the touch path event in each direction to a predefined length. The various aspects may also include a method for providing a user interface gesture function on a computing device including comparing the number of times the direction of the touch path event reverses to a predefined number. Determining the length of the touch path event in each direction may include detecting the end of a touch path event. Activating a function associated with the tickle gesture may include activating a menu function including a menu selection item, and displaying the menu selection item. Activating a function associated with the tickle gesture may also include determining a location of the touch path event in the user interface display, displaying the menu selection item based on the determined touch path event location, determining when the touch path event is ended, and activating the menu selection item associated with the determined touch path event location when it is determined that the touch path event is ended. Activating a function associated with the tickle gesture may also include determining a location of the touch path event in the user interface display, detecting a motion associated with the touch path event, displaying the menu selection items based on the determined touch path event motion and location, determining when the touch path event is ended, and activating the menu selection item associated with the determined touch path event location when it is determined that the touch path event is ended.

In an aspect a computing device may include a processor, a user interface pointing device coupled to the processor, a memory coupled to the processor, and a display coupled to the processor, in which the processor is configured to detect a touch path event on a user interface device, determine whether the touch path event is a tickle gesture, and activate a function associated with the tickle gesture when it is determined that the touch path event is a tickle gesture. The processor may determine whether the touch path event is a tickle gesture by determining that the touch path event traces an approximately linear path, detecting a reversal in direction of the touch path event, determining a length of the touch path event in each direction, and determining a number of times the direction of the touch path event reverses. The processor may detect a reversal in the direction of the touch path event by detecting whether the direction of the touch path event is approximately opposite that of a prior direction. The processor may also be configured to compare the length of the touch path event in each direction to a predefined length. The processor may also be configured to compare the number of times the direction of the touch path event reverses to a predefined number. The processor may determine the length of the touch path event in each direction by detecting the end of a touch path event. Activating a function associated with the tickle gesture may include activating a menu function including a menu selection item, and displaying the menu selection item. The processor may also be configured to determine a location of the touch path event in the user interface display, display the menu selection item based on the determined touch path event location, determine when the touch path event is ended, and activate the menu selection item associated with the determined touch path event location when it is determined that the touch path event is ended. The processor may also be configured to detect a motion associated with the touch path event, display the menu selection items based on the determined touch path event motion and location, determine when the touch path event is ended, and activate the menu selection item associated with the determined touch path event location when it is determined that the touch path event is ended.

In an aspect, a computing device includes a means for detecting a touch path event on a user interface device, a means for determining whether the touch path event is a tickle gesture, and a means for activating a function associated with the tickle gesture when it is determined that the touch path event is a tickle gesture. The computing device may further include a means for determining that the touch path event traces an approximately linear path, a means for detecting a reversal in direction of the touch path event, a means for determining a length of the touch path event in each direction, and a means for determining a number of times the direction of the touch path event reverses. The reversal in the direction of the touch path event may be in an approximately opposite direction. The computing device may also include a means for comparing the length of the touch path event in each direction to a predefined length. The computing device may also include a means for comparing the number of times the direction of the touch path event reverses to a predefined number. The means for determining the length of the touch path event in each direction may include a means for detecting the end of a touch path event. The means for activating a function associated with the tickle gesture may include a means for activating a menu function including a menu selection item, and a means for displaying the menu selection item. The computing device may also include a means for determining a location of the touch path event in the user interface display, a means for displaying the menu selection item based on the determined touch path event location, a means for determining when the touch path event is ended, and a means for activating the menu selection item associated with the determined touch path event location when it is determined that the touch path event is ended. The computing device may also include a means for determining a location of the touch path event in the user interface display, a means for detecting a motion associated with the touch path event, a means for displaying the menu selection items based on the determined touch path event motion and location, a means for determining when the touch path event is ended, and a means for activating the menu selection item associated with the determined touch path event location when it is determined that the touch path event is ended.

In an aspect a computer program product may include a computer-readable medium including at least one instruction for detecting a touch path event on a user interface device, at least one instruction for determining whether the touch path event is a tickle gesture, and at least one instruction for activating a function associated with the tickle gesture when it is determined that the touch path event is a tickle gesture. The computer-readable medium may also include at least one instruction for determining that the touch path event traces an approximately linear path, at least one instruction for detecting a reversal in direction of the touch path event, at least one instruction for determining the length of the touch path event in each direction, and at least one instruction for determining the number of times the direction of the touch path event reversals. The at least one instruction for detecting a reversal in the direction of the touch path event may include at least one instruction for detecting whether the reversal in the direction of the touch path event is to an approximately opposite direction. The computer-readable medium may also include at least one instruction for comparing the length of the touch path event in each direction to a predefined length. The computer-readable medium may also include at least one instruction for comparing the number of times the direction of the touch path event reverses to a predefined number. The at least one instruction for determining the length of the touch path event in each direction may include at least one instruction for detecting the end of a touch path event. The at least one instruction activating a function associated with the tickle gesture may include at least one instruction for activating a menu function including a menu selection item, and at least one instruction for displaying the menu selection item. The computer-readable medium may also include at least one instruction for determining a location of the touch path event in the user interface display, at least one instruction for displaying the menu selection item based on the determined touch path event location, at least one instruction for determining when the touch path event is ended, and at least one instruction for activating the menu selection item associated with the determined touch path event location when it is determined that the touch path event is ended. The computer-readable medium may also include at least one instruction for detecting a motion associated with the touch path event, at least one instruction for displaying the menu selection items based on the determined touch path event motion and location, at least one instruction for determining when the touch path event is ended, and at least one instruction for activating the menu selection item associated with the determined touch path event location when it is determined that the touch path event is ended.

### BRIEF DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the invention.

FIG. 1 is a frontal view of a portable computing device illustrating a tickle gesture functionality activated by a finger moving in an up and down direction on a touchscreen display according to an aspect.

FIG. 2 is a frontal view of a portable computing device illustrating tickle gesture functionality activated to display an index menu according to an aspect.

FIG. 3 is a frontal view of a portable computing device illustrating navigating an index menu by moving a finger downwards on a touchscreen according to an aspect.

FIG. 4 is a frontal view of a portable computing device illustrating a display of selected menu item.

FIG. 5 is a frontal view of a portable computing device illustrating navigating an index menu by moving a finger downwards on a touchscreen according to an aspect.

FIG. 6 is a frontal view of a portable computing device illustrating activating tickle gesture functionality by a finger moving in an up and down direction on a touchscreen display according to an aspect.

FIG. 7 is a frontal view of a portable computing device illustrating a display of an index menu following a tickle gesture according to an aspect.

FIG. 8 is a frontal view of a portable computing device illustrating tickle gesture functionality activated to display an index menu according to an aspect.

FIGS. 9 and 10 are frontal views of a portable computing device illustrating tickle gesture functionality activated to display an index menu according to an aspect.

FIG. 11 is a frontal view of a portable computing device illustrating display of a selected menu item according to an aspect.

FIG. 12 is a frontal view of a portable computing device illustrating display of a tickle gesture visual guide according to an aspect.

FIG. 13 is a system block diagram of a computer device suitable for use with the various aspects.

FIG. 14 is a process flow diagram of an aspect method for activating a tickle gesture function.

FIG. 15 is a process flow diagram of an aspect method for implementing a tickle gesture function user interface using a continuous tickle gesture.

FIG. 16 is a process flow diagram of an aspect method for implementing a tickle gesture function user interface using a discontinuous tickle gesture.

FIG. 17 is a process flow diagram of a method for selecting an index menu item according to the various aspects.

FIG. 18 is a component block diagram of an example portable computing device suitable for use with the various aspects.

FIG. 19 is a circuit block diagram of an example computer suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The word “tickle gesture” is used herein to mean alternating repetitious strokes (e.g., back and forth, up and down, or down-lift-down strokes), performed on a touchscreen user interface.

As used herein, a “touchscreen” is a touch sensing input device or a touch sensitive input device with an associated image display. As used herein, a “touchpad” is a touch sensing input device without an associated image display. A touchpad, for example, can be implemented on any surface of an electronic device outside the image display area. Touchscreens and touchpads are generically referred to herein as a “touch surface.” Touch surfaces may be integral parts of an electronic device, such as a touchscreen display, or a separate module, such as a touchpad, which can be coupled to the electronic device by a wired or wireless data link. The terms touchscreen, touchpad and touch surface may be used interchangeably hereinafter.

As used herein, the terms “personal electronic device,” “computing device” and “portable computing device” refer to any one or all of cellular telephones, personal data assistants (PDAs), palm-top computers, notebook computers, personal computers, wireless electronic mail receivers and cellular telephone receivers (e.g., the Blackberry® and Treo® devices), multimedia Internet enabled cellular telephones (e.g., the Blackberry Storm®), and similar electronic devices that include a programmable processor, memory, and a connected or integral touch surface or other pointing device (e.g., a computer mouse). In an example aspect used to illustrate various aspects of the present invention, the electronic device is a cellular telephone including an integral touchscreen display. However, this aspect is present merely as one example implementation of the various aspects, and as such is not intended to exclude other possible implementations of the subject matter recited in the claims.

As used herein a “touch event” refers to a detected user input on a touch surface that may include information regarding location or relative location of the touch. For example, on a touchscreen or touchpad user interface device, a touch event refers to the detection of a user touching the device and may include information regarding the location on the device being touched.

As used herein the term “path” refers to a sequence of touch event locations that trace a path within a graphical user interface (GUI) display during a touch event. Also, as used herein the term “path event” refers to a detected user input on a touch surface which traces a path during a touch event. A path event may include information regarding the locations or relative locations (e.g., within a GUI display) of the touch events which constitute the traced path.

The various aspect methods and devices provide an intuitively easy to use touchscreen user interface gesture for performing a function, such as opening an application or activating a search function. Users may perform a tickle gesture on their computing device by touching the touchscreen with a finger and tracing a tickle gesture on the touchscreen. The tickle gesture is performed when a user traces a finger in short strokes in approximately opposite directions (e.g., back and forth or up and down) on the touchscreen display of a computing device.

The processor of a computing device may be programmed to recognize touch path events traced in short, opposite direction strokes as a tickle gesture and, in response, perform a function linked to or associated with the tickle gesture (i.e., a tickle gesture function). The path traced by a tickle gesture may then be differentiated from other path shapes, such as movement of a finger in one direction on a touchscreen for panning, zooming or selecting.

Functions that may be linked to and initiated by a tickle gesture may include opening an application such as an address book application, a map program, a game, etc. The tickle gesture may also be associated with activating a function within an application. For example, the tickle gesture may activate a search function allowing the user to search a database associated with an open application, such as searching for names in an address book.

Tickle gestures may be traced in different manners. For example, tickle gestures may be continuous or discontinuous. In tracing a continuous tickle gesture, a user may maintain contact of his/her finger on the touchscreen display during the entire tickle gesture. Alternatively, the user may discontinuously trace the tickle gesture by touching the touchscreen display in the direction of a tickle gesture stroke. For example, in a discontinuous tickle gesture the user may touch the touchscreen display, trace a downward stroke, and lift his/her finger off the touchscreen display before tracing a second downward stroke (referred to herein as a “down-lift-down” path trace). The computing device processor may be configured to recognize such discontinuous gestures as a tickle gesture.

Parameters such as the length, repetition, and duration of the path traced in a tickle gesture touch event may be measured and used by the processor of a computing device to control the performance of the function linked to, or associated with, the tickle gesture. The processor may be configured to determine whether the path traced does not exceed a pre-determined stroke length, and whether the path includes a minimum number of repetitions of tickle gesture strokes within a specified time period. Such parameters may allow the processor to differentiate between other user interface gestures that may be similar in part to the tickle gesture. For example, a gesture that may activate a panning function may be differentiated from a tickle gesture based on the length of a stroke, since the panning function may require one long stroke of a finger in one direction on a touchscreen display. The length of the strokes of a tickle gesture may be set at an arbitrary number, such as 1 centimeter, so that it does not interfere with other gestures for activating or initiating other functions.

A minimum number of stroke repetitions may be associated with the tickle gesture. The number of stroke repetitions may be set arbitrarily or as a user—settable parameter, and may be selected to avoid confusion with other gestures for activating other functions. For example, the user may be required to make at least five strokes each less than 1 centimeter before the computing device recognizes the touch event as a tickle gesture.

The tickle gesture may also be determined based upon a time limit within which the user must execute the required strokes. Time limit may also be arbitrary or a user-settable parameter. Such time limits may allow the computing device to differentiate the tickle gesture from other gestures which activate different functions. For example, one stroke followed by another stroke more than 0.5 seconds later may be treated as conventional user gesture, such as panning, whereas one stroke followed by another in less than 0.5 seconds may be recognized as a tickle gesture, causing the processor to activate the linked functionality. The time limit may be imposed as a time out on the evaluation of a single touch path event such that if the tickle gesture parameters have not been satisfied by the end of the time limit, the touch path is immediately processed as a different gesture, even if the gesture later satisfies the tickle gesture parameters.

In the various aspects the tickle gesture functionality may be enabled automatically as part of the GUI software. Automatic activation of the tickle gesture functionality may be provided as part of an application.

In some aspects, the tickle gesture functionality may be automatically disabled by an application that employs user interface gestures that might be confused with the tickle gesture. For example, a drawing application may deactivate the tickle gesture so that drawing strokes are not misinterpreted as a tickle gesture.

In some aspects, the tickle gesture may be manually enabled. To manually enable or activate the tickle gesture in an application, a user may select and activate the tickle gesture by pressing a button or by activating an icon on a GUI display. For example, the index operation may be assigned to a soft key, which the user may activate (e.g., by pressing or clicking) to launch the tickle gesture functionality. As another example, the tickle gesture functionality may be activated by a user command. For example, the user may use a voice command such as “activate index” to enable the tickle gesture functionality. Once activated, the tickle gesture functionality may be used in the manner described herein.

The tickle gesture functionality may be implemented on any touch surface. In a particularly useful implementation, the touch surface is a touchscreen display since touchscreens are generally superimposed on a display image, enabling users to interact with the display image with the touch of a finger. In such applications, the user interacts with an image by touching the touchscreen display with a finger and tracing back and forth or up and down paths. Processes for the detection and acquisition of touchscreen display touch events (i.e., detection of a finger touch on a touchscreen) are well known, an example of which is disclosed in U.S. Pat. No. 6,323,846, the entire contents of which are hereby incorporated by reference.

When the required tickle gesture parameters are detected, the linked gesture function may be activated. The function linked to, or associated with, the tickle gesture may include opening an application or activating a search function. If the linked function is opening an application, the computing device processor may open the application and display it to the user on the display, in response to the user tracing a tickle gesture that satisfies the required parameters.

If the linked function is activating a search functionality, when the required tickle gesture parameters are detected, the processor may generate a graphical user interface display that enables the user to conduct a search in the current application. Such a graphical user interface may include an index, which may be used to search a list of names, places, or topics arranged in an orderly manner. For example, when searching an address book, the search engine may display to the user an alphabetically arranged index of letters. A user may move between different alphabet letters by tracing his/her finger in one direction or the other on the touchscreen display. Similarly, when searching a document or a book, an index may include a list of numerically arranged chapter numbers for the document or book. In that case a user may navigate the chapters by tracing a path on a touchscreen or touch surface while the search function is activated.

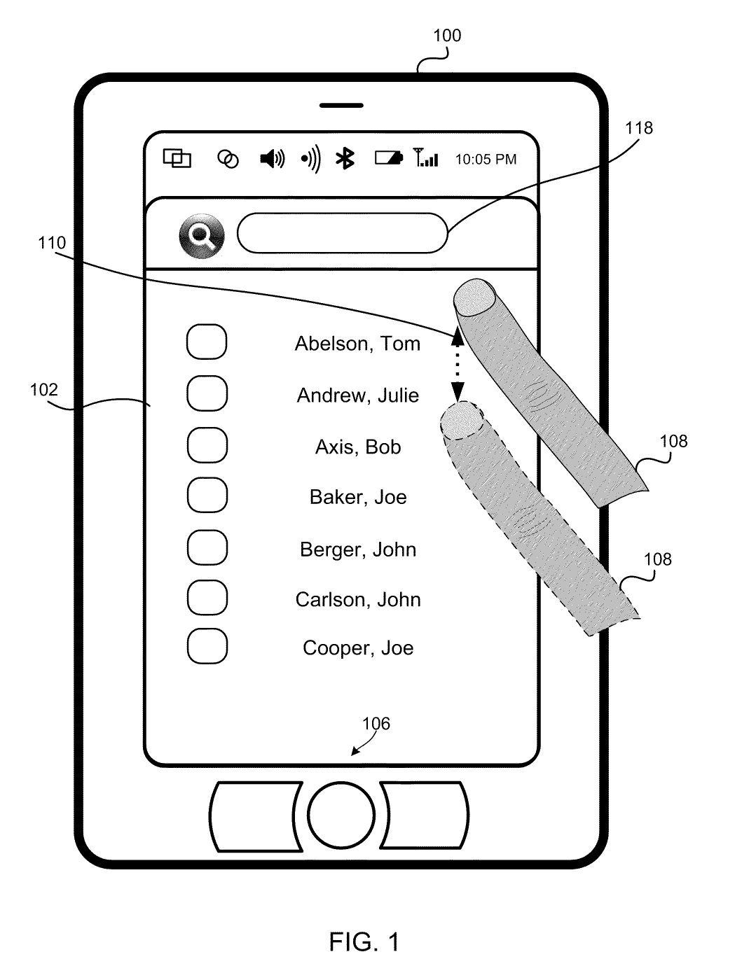

FIG. 1 shows an example computing device 100 that includes a touchscreen display 102 and function keys 106 for interfacing with a graphical user interface. In the illustrated example, the computing device 100 is running an address book application which displays the names of several contacts on the touchscreen display 102. The names in the address book may be arranged alphabetically. To access a name, the address book application may allow the user to scroll down an alphabetically arranged list of names. Alternatively, the address book application may enable the user to enter a name in the search box 118 that the application uses to search the address book database. These methods may be time consuming for the user. Scrolling down a long list of names may take a long time in large databases. Similarly, searching for a name using the search function also takes time to enter the search term and perform additional steps. For example, to search a name database using the search box 118, the user must type in the name, activate the search function, access another page with the search results, and select the name. Further, in many applications or user interface displays typing an entry also involves activating a virtual keyboard or pulling out a hard keyboard and changing the orientation of the display.

In an aspect, a user may activate a search function for searching the address book application by touching the touchscreen with a finger 108, for example, and moving the finger 108 to trace a tickle gesture. An example direction and the general shape of the path that a user may trace to make a tickle gesture are shown by the dotted line 110. The dotted line 110 is shown to indicate the shape and direction of the finger 108 movement and is not included as part of the touchscreen display 102 in the aspect illustrated in FIG. 1.

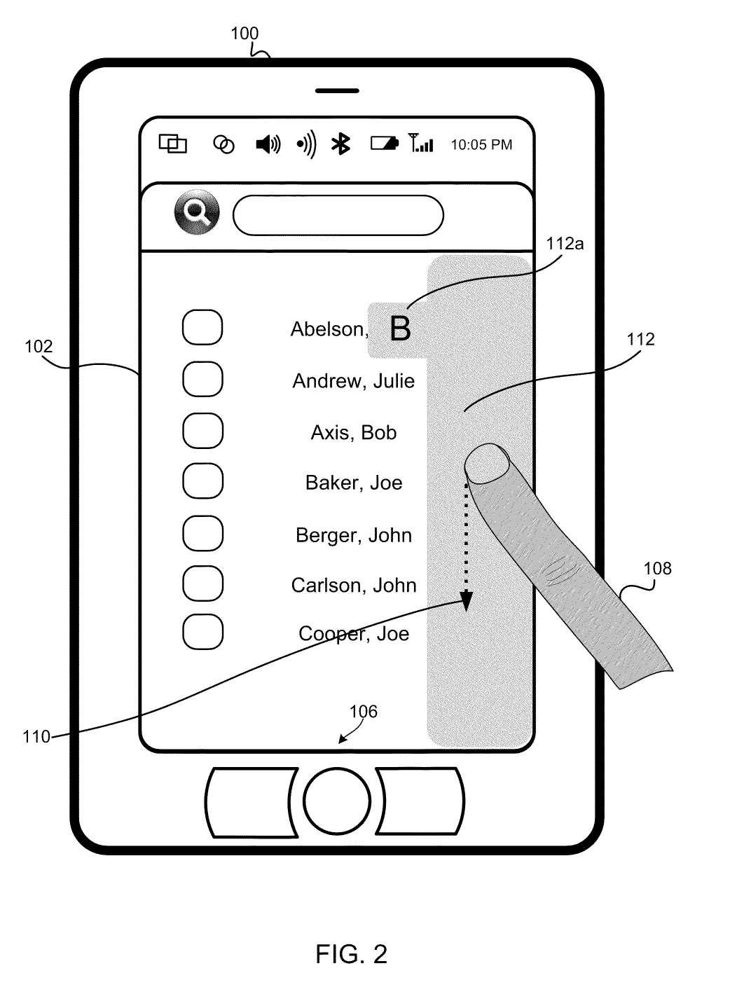

As illustrated in FIG. 2, once the search functionality is activated by a tickle gesture, an index menu 112 may be displayed. The index menu 112 may allow the user to search through the names in the address book by displaying an alphabetical tab 112a. As the user's finger 108 moves up or down, alphabet letters may be shown in sequence in relation to the vertical location of the finger touch. FIG. 2 shows the finger 108 moving downwards, as indicated by the dotted line 110.

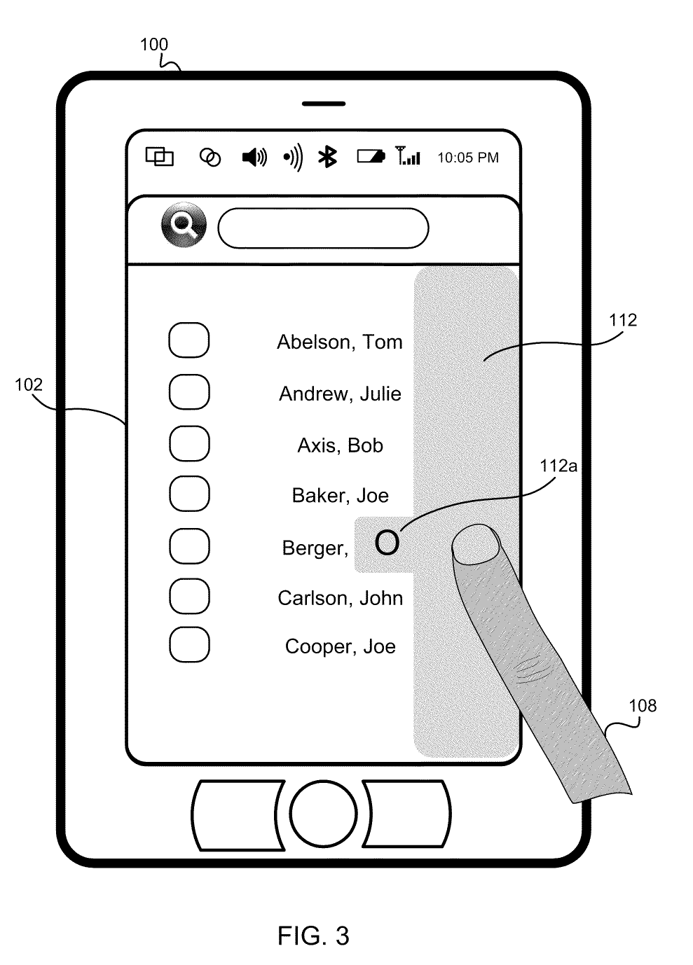

As illustrated in FIG. 3, when the user's finger 108 stops, the index menu 112 may display an alphabet tab 112a in relation to the vertical location of the finger touch on the display. To jump to a listing of names beginning with a particular letter, the user moves his/her finger 108 up or down until the desired alphabet tab 112a is displayed, at which time the user may pause (i.e., stop moving the finger on the touchscreen display). In the example shown in FIG. 3, the letter “O” tab is presented indicating that the user may jump to contact records for individuals whose name begins with the letter “O”.

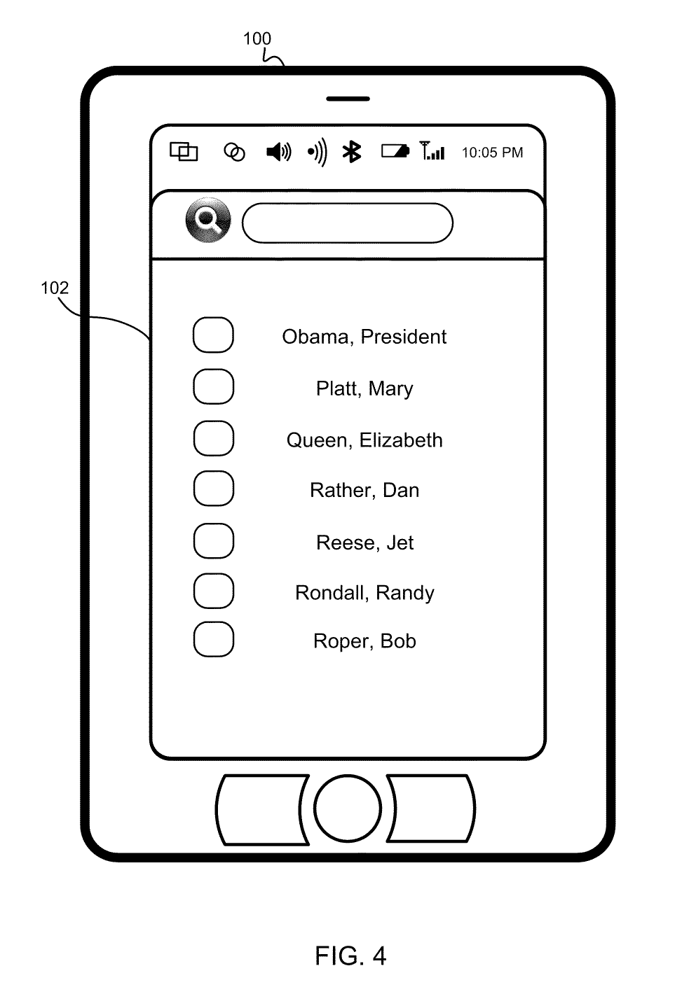

To jump to a listing of names beginning with the letter on a displayed tab, the user lifts his/her finger 108 off of the touch surface. The result is illustrated in FIG. 4, which shows the results of lifting the finger 108 from the touchscreen display 102 while the letter “O” is displayed in the alphabetical tab 112a. In this example, the computer device 100 displays the names in the address book that begin with the letter “O”.

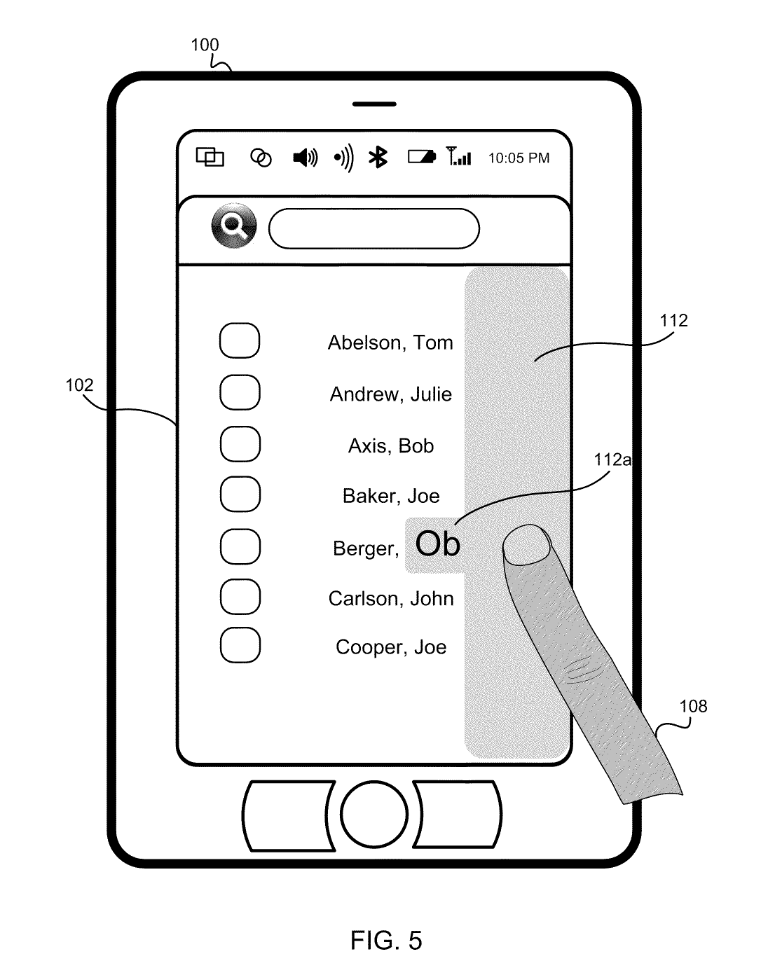

The speed in which the user traces a path while using the index menu may determine the level of information detail that may be presented to the user. Referring back to FIG. 3, the alphabetical tab 112a may only display the letter “O” when the user traces his/her finger 108 up or down the touchscreen display 102 in a fast motion. In an aspect illustrated in FIG. 5, the user may trace his/her finger 108 up or down the touchscreen display 102 at a medium speed to generate a display with more information in the alphabetical tab 112a, such as “Ob” which includes the first and second letter of a name in the address book database. When the user lifts his/her finger 108 from the touchscreen display 102 (as shown in FIG. 4), the computing device 100 may display all the names that begin with the displayed two letters.

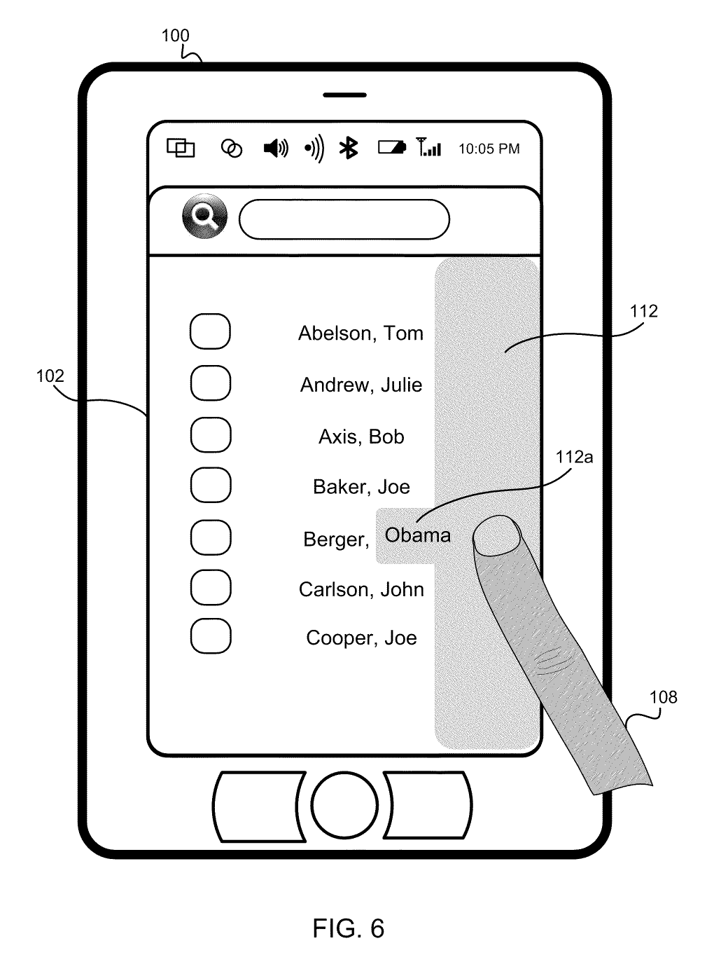

In a further aspect illustrated in FIG. 6, the user may trace his/her finger 108 down the touchscreen display 102 at a slow speed to generate a display with even more information on the alphabetical tab 112a, such as the entire name of particular contact records. When the user lifts his/her finger 108 from the touchscreen display 102, the computing device 100 may display a list of contacts with the selected name (as shown in FIG. 4), or open the data record of the selected name if there is only a single contact with that name.

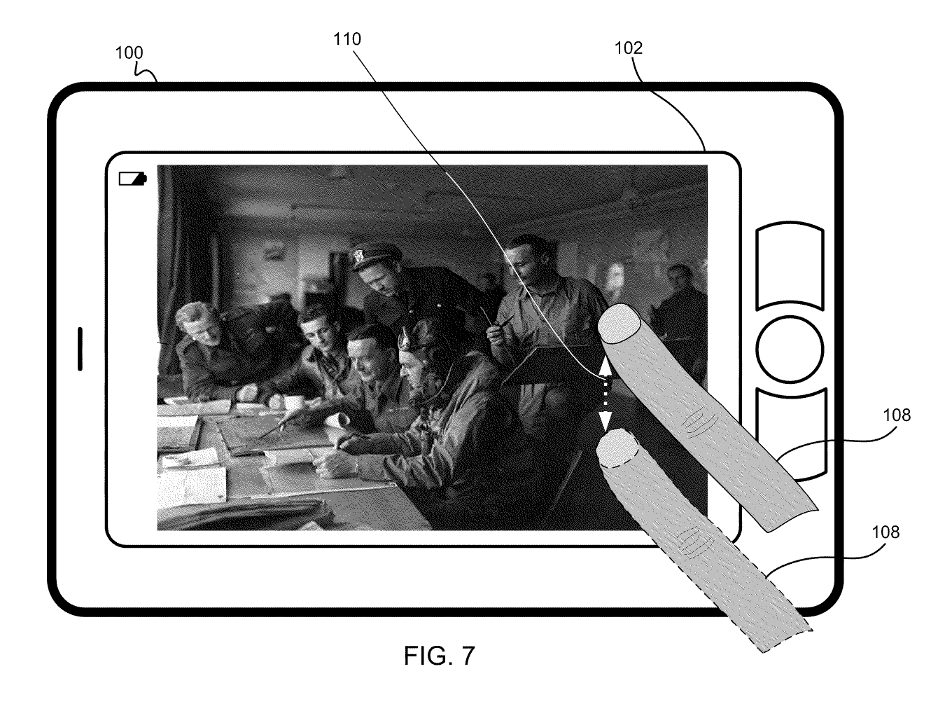

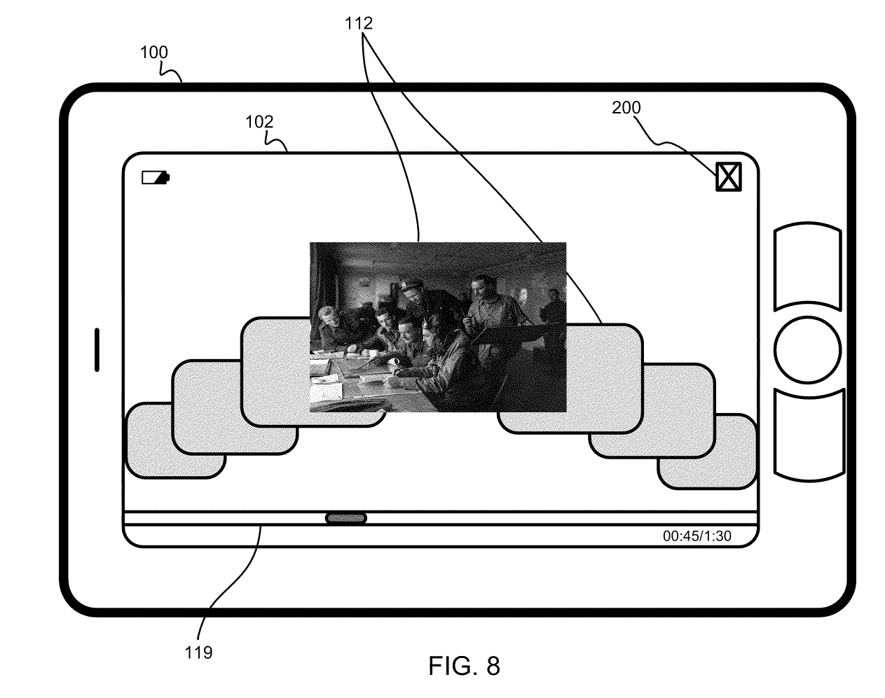

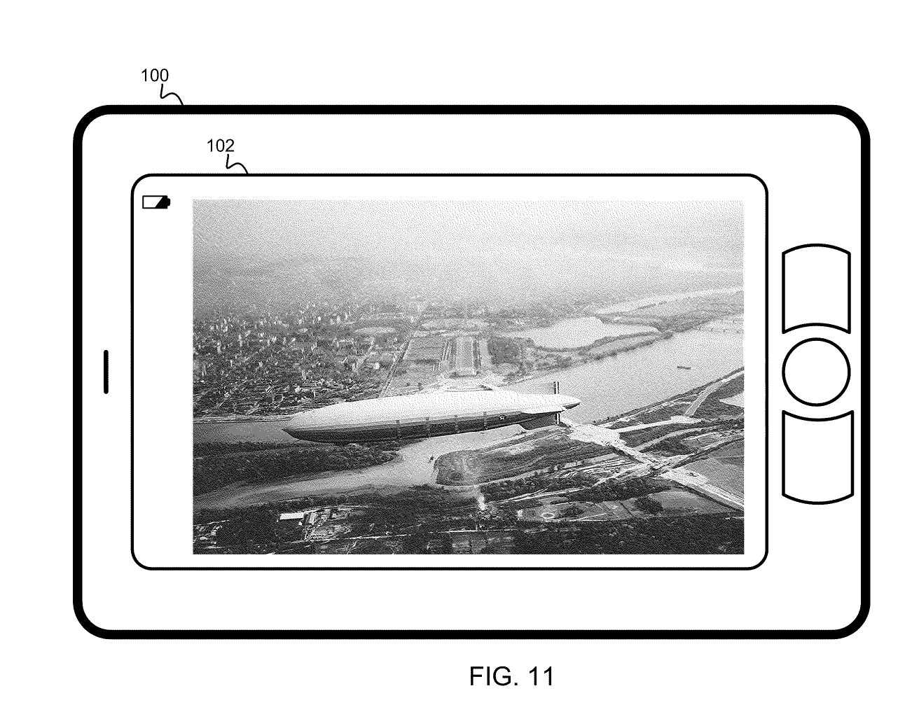

FIGS. 7 and 8 illustrate the use of the tickle gesture to activate search functionality within a multimedia application. In the example implementation, when a user's finger 108 traces a tickle gesture on the touchscreen display 102 while watching a movie, as shown in FIG. 7, a video search functionality may be activated. As illustrated in FIG. 8, activation of the search functionality while watching a movie may activate an index menu 112, including movie frames and a scroll bar 119 to allow the user to select a point in the movie to watch. In this index menu, the user may navigate back and forth through the movie frames to identify the frame from which the user desires to resume watching the movie. Other panning gestures may also be used to navigate through the movie frames. Once a desired movie frame is selected, by for example, bringing the desired frame to the foreground, the user may exit the index menu 112 screen by, for example, selecting an exit icon 200, or repeating the tickle gesture. Closing the search functionality by exiting the index menu 112 may initiate the video from the point selected by the user from the index menu 112, which is illustrated in FIG. 11.

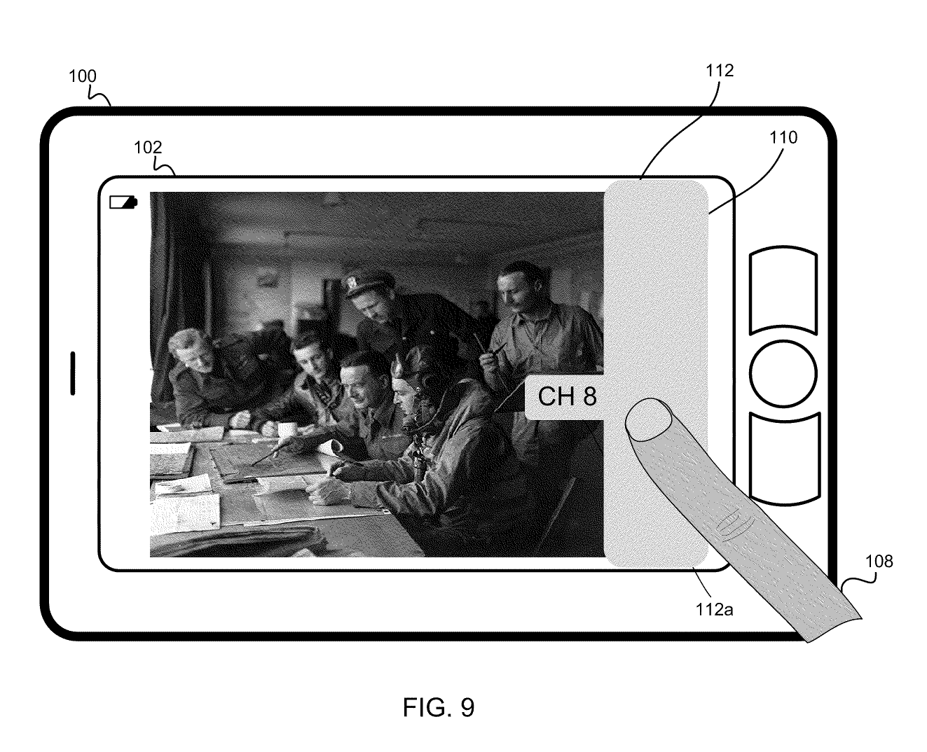

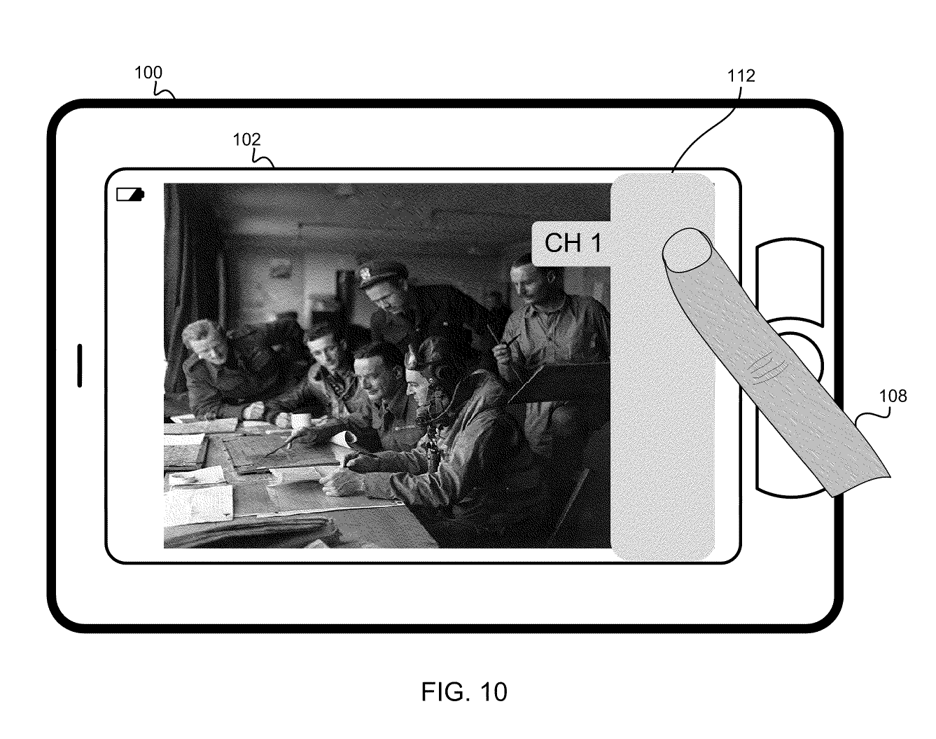

In another example illustrated in FIG. 9, the tickle gesture in a movie application may activate a search function that generates an index menu 112 including movie chapters in a chapter tab 112a. For example, once the search function is activated by a tickle gesture, the current movie chapter may appear (the illustrated example shown in FIG. 8). As the user moves his/her finger 108 up or down, the chapter number related to the vertical location of the finger 108 touch may appear in the chapter tab 112a. FIG. 10 illustrates this functionality as the user's finger 108 has reached the top of the display 104, so the chapter tab 112a has changed from chapter 8 to chapter 1. By lifting the finger 108 from the touchscreen display 102, the user informs the computing device 100 in this search function to rewind the movie back to the chapter corresponding to the chapter tab 112a. In this example, the movie will start playing from chapter 1, which is illustrated in FIG. 11.

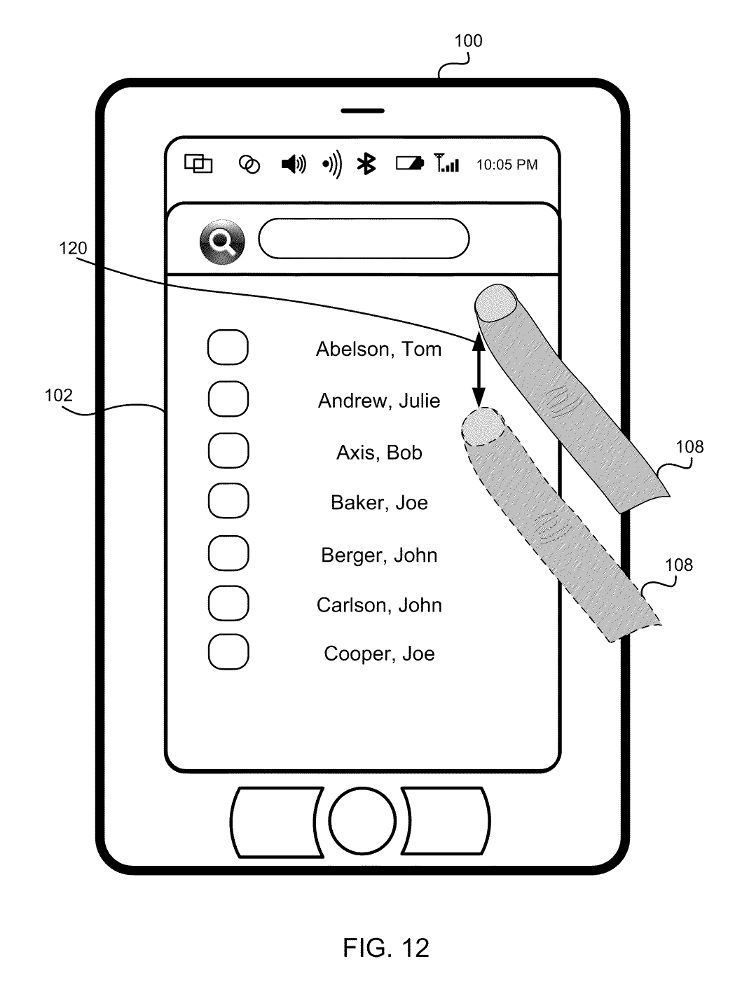

In an alternative aspect, the tickle gesture functionality within the GUI may be configured to display a visual aid within the GUI display to assist the user in tracing a tickle gesture path. For example, as illustrated in FIG. 12, when the user begins to trace a tickle gesture, a visual guide 120 may be presented on the touchscreen display 102 to illustrate the path and path length that the user should trace to activate the tickle gesture function.

The GUI may be configured so the visual guide 120 is displayed in response to a number of different triggers. In one implementation, a visual guide 112 may appear on the touchscreen display 102 in response to the touch of the user's finger. In this case, the visual guide 120 may appear each time the tickle gesture functionality is enabled and the user touches the touchscreen display 102. In a second implementation, the visual guide 120 may appear in response to the user touching and applying pressure to the touchscreen display 102 or a touchpad. In this case, just touching the touchscreen display 102 (or a touchpad) and tracing a tickle gesture will not cause a visual guide 120 to appear, but the visual guide 120 will appear if the user touches and presses the touchscreen display 102 or touchpad. In a third implementation, a soft key may be designated which when pressed by the user initiates display of the visual guide 120. In this case, the user may view the visual guide 120 on the touchscreen display 102 by pressing the soft key, and then touch the touchscreen to begin tracing the shape of the visual guide 120 in order to activate the function linked to, or associated with, the tickle gesture. In a fourth implementation, the visual guide 120 may be activated by voice command, as in the manner of other voice activated functions that may be implemented on the portable computing device 100. In this case, when the user's voice command is received and recognized by the portable computing device 100, the visual guide 120 is presented on the touchscreen display 102 to serve as a visual aid or guide for the user.

The visual guide 120 implementation description provided above is only one example of visual aids that may be implemented as part of the tickle gesture functionality. As such, these examples are not intended to limit the scope of the present invention. Further, the tickle gesture functionality may be configured to enable users to change the display and other features of the function, based on their individual preferences, by using known methods. For example, users may turn off the visual guide 120 feature, or configure the tickle gesture functionality to show a visual guide 120 only when the user touches and holds a finger in one place on the touchscreen for a period of time, such as more than 5 seconds.

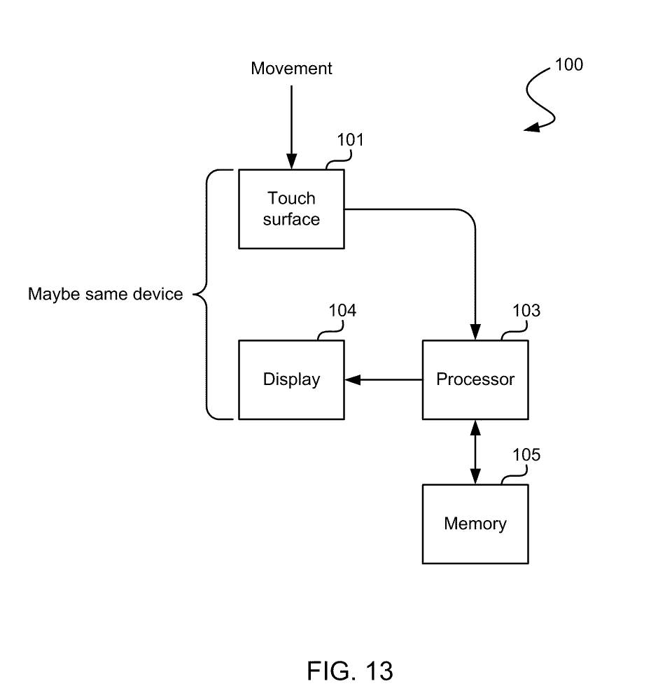

FIG. 13 illustrates a system block diagram of software and/or hardware components of a computing device 100 suitable for use in implementing the various aspects. The computing device 100 may include a touch surface 101, such as a touchscreen or touchpad, a display 104, a processor 103, and a memory device 105. In some computing devices 100, the touch surface 101 and the display 104 may be the same device, such as a touchscreen display 102. Once a touch event is detected by the touch surface 101, information regarding the position of the touch is provided to the processor 103 on a near continuous basis. The processor 103 may be programmed to receive and process the touch information and recognize a tickle gesture, such as an uninterrupted stream of touch location data received from the touch surface 101. The processor 103 may also be configured to recognize the path traced during a tickle gesture touch event by, for example, noting the location of the touch at each instant and movement of the touch location over time. Using such information, the processor 103 can determine the traced path length and direction, and from this information recognize a tickle gesture based upon the path length, direction, and repetition. The processor 103 may also be coupled to memory 105 that may be used to store information related touch events, traced paths, and image processing data.

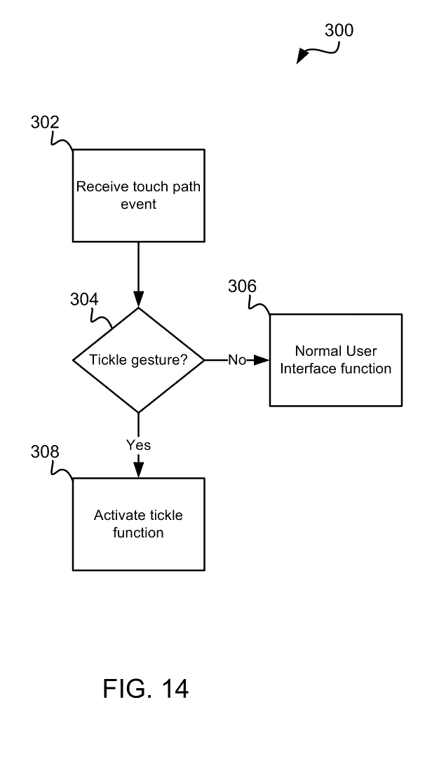

FIG. 14 illustrates a process 300 for activating the tickle gesture function on a computing device 100 equipped with a touchscreen display 102. In process 300 at block 302, the processor 103 of a computing device 100 may be programmed to receive touch events from the touchscreen display 102, such as in the form of an interrupt or message indicating that the touchscreen display 102 is being touched. At decision block 304, the processor 103 may then determine whether the touch path event is a tickle gesture based on the touch path event data. If the touch path event is determined not to be a tickle gesture (i.e., decision block 304=“No”), the processor 103 may continue with normal GUI functions at block 306. If the touch path event is determined to be a tickle gesture (i.e., decision block 304=“Yes”), the processor 103 may activate a function linked to or associated with the tickle gesture at block 308.

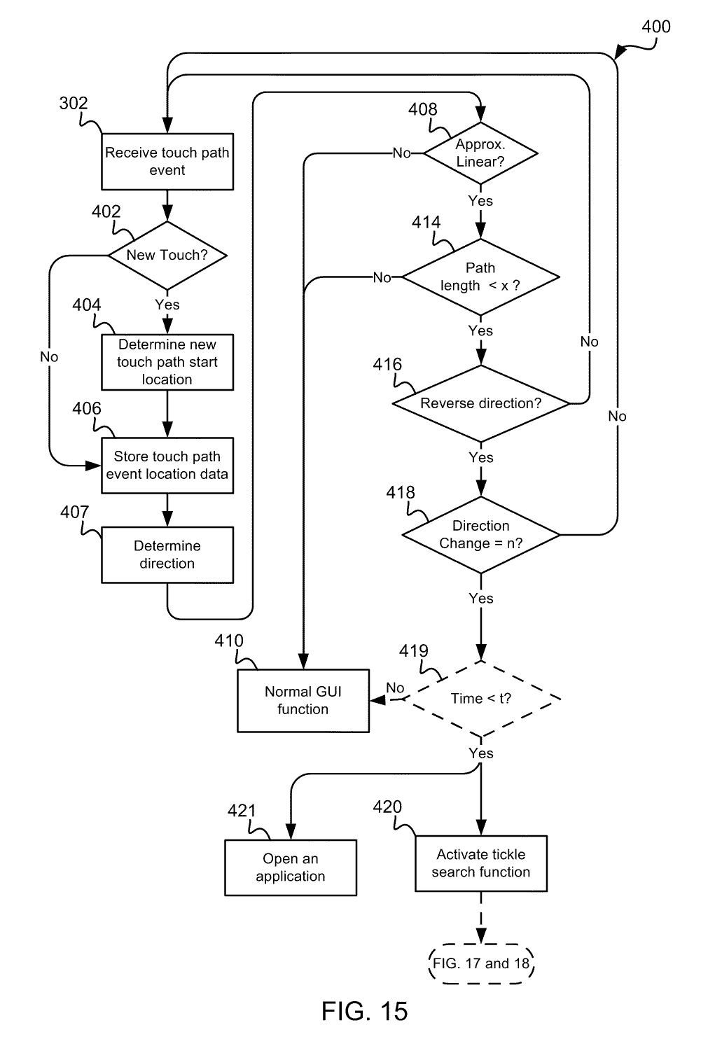

FIG. 15 illustrates an aspect process 400 for detecting continuous tickle gesture touch events. In process 400 at block 302, the processor 103 may be programmed to receive touch path events, and determine whether the touch path event is a new touch, decision block 402. If the touch path event is determined to be from a new touch (i.e. decision block 402=“Yes”), the processor 103 may determine the touch path event location on the touchscreen display 102, at block 404, and store the touch path event location data, block 406. If the touch path event is determined not to be from a new touch (i.e., decision block 402=“No”), the processor continues to store the location of the current touch path event, at block 406.

In determining whether the touch path event is a continuous tickle gesture and to differentiate a tickle gesture from other GUI functions, the processor 103 may be programmed to identify different touch path event parameters based on predetermined measurements and criteria, such as the shape of the path event, the length of the path event in each direction, the number of times a path event reverses directions, and the duration of time in which the path events occur. For example in process 400 at block 407, the processor 103 may determine the direction traced in the touch path event, and at decision block 408, determine whether the touch path event is approximately linear. While users may attempt to trace a linear path with their fingers, such traced paths will inherently depart from a purely linear path due to variability in human movements and to variability in touch event locations, such as caused by varying touch areas and shapes due to varying touch pressure. Accordingly, as part of decision block 408 the processor may analyze the stored touch events to determine whether they are approximately linear within a predetermined tolerance. For example, the processor may compute a center point of each touch event, trace the path through the center points of a series of touch events representing a tickle stroke, apply a tolerance to each point, and determine whether the points form a approximately linear line within the tolerance. As another example, the processor may compute a center point of each touch event, trace the path through the center points of a series of touch events representing a tickle stroke, define a straight that best fits the center points (e.g., by using a least squares fit), and then determining whether the deviation from the best fit straight line fits all of the points within a predefined tolerance (e.g., by calculating a variance for the center points), or determining whether points near the end of the path depart further from the best fit line than do points near the beginning (which would indicate the path is curving). The tolerances used to determine whether a traced path is approximately linear may be predefined, such as plus or minus ten percent (10%). Since any disruption caused by an inadvertent activation of a search menu (or other function linked to the tickle gesture) may be minor, the tolerance used for determining whether a trace path is approximately equal may be relatively large, such as thirty percent (30%), without degrading the user experience.

In analyzing the touch path event to determine whether the path is approximately linear (decision block 408) and reverses direction a predetermined number of times (decision blocks 416 and 418), the processor will analyze a series of touch events (e.g., one every few milliseconds, consistent with the touch surface refresh rate). Thus, the processor will continue to receive and process touch events in blocks 302, 406, 407 until the tickle gesture can be distinguished from other gestures and touch surface interactions. One way the processor can distinguish other gestures is if they depart from being approximately linear. Thus, if the touch path event is determined not to be approximately linear (i.e., decision block 408=“No”), the processor 103 may perform normal GUI functions at block 410, such as zooming or panning. However, if the touch path event is determined to be approximately linear (i.e., decision block 408=“Yes”), the processor 103 may continue to evaluate the touch path traced by received touch events to evaluate other bases for differentiating the tickle gesture from other gestures.

A second basis for differentiating the tickle gesture from other touch path events is the length of a single stroke since the tickle gesture is defined as a series of short strokes. Thus, at decision block 414 as the processor 103 receives each touch event, the processor may determine whether the path length in one direction is less than a predetermined value “x”. Such a predetermined path length may be used to allow the processor 103 to differentiate between a tickle gesture and other linear gestures that may include tracing a path event on a touchscreen display 102. If the path length in one direction is greater than the predetermined value “x” (i.e., decision block 414=“No”), this indicates that the touch path event is not associated with the tickle gesture so the processor 103 may perform normal GUI functions at block 410. For example, the predetermined value may be 1 centimeter. In such a scenario, if the path event length extends beyond 1 cm in one direction, the processor 103 may determine that the path event is not a tickle gesture and perform functions associated with other gestures.

A third basis for differentiating the tickle gesture from other touch path events is whether the path reverses direction. Thus, if the path length in each direction is less than or equal to the predetermined value (i.e., decision block 414=“Yes”), the processor 103 may continue to evaluate the touch path traced by the received touch events to determine whether the path reverses direction at decision block 416. A reversal in the direction of the traced path may be determined by comparing the direction of the traced path determined in block 407 to a determined path direction in the previous portion of the traced path to determine whether the current path direction is approximately 180 degrees from that of the previous direction. Since there is inherent variability in human actions and in the measurement of touch events on a touch surface, the processor 103 may determine that a reversal in path direction has occurred when the direction of the path is between approximately 160° and approximately 200° of the previous direction within the same touch path event. If the processor 103 determines that the touch path does not reverse direction (i.e., determination block 416=“No”), the processor 103 may continue receiving and evaluating touch events by returning to block 302. The process 400 may continue in this manner until the path length departs from being approximately linear (i.e., decision block 408=“No”), a stroke length exceeds the predetermined path length (i.e., decision block 414=“No”), or the traced path reverses direction (i.e., decision block 416=“Yes”).

If the touch pad event reverses directions (i.e., decision block 416=“Yes”), the processor 103 may determine whether the number of times the path event has reversed directions exceeds a predefined value (“n”) in decision block 418. The predetermined number of times that a path event must reverse direction before the processor 103 recognizes it as a tickle gesture determines how much “tickling” is required to initiate the linked function. If the number of times the touch pad event reverses direction is less than the predetermined number “n” (i.e., decision block 418=“No”), the processor 103 may continue to monitor the gesture by returning to block 302. The process 400 may continue in this manner until the path length departs from being approximately linear (i.e., decision block 408=“No”), a stroke length exceeds the predetermined path length (i.e., decision block 414=“No”), or the number of times the touch pad event reverses direction is equal to the predetermined number “n” (i.e., decision block 418=“Yes”). When the number of strokes is determined to equal the predetermined number “n”, the processor 103 may activate the function linked to the tickle gesture, such as activating a search function at block 420 or opening an application at block 421. For example, when “n” is five direction reversals, the processor 103 may recognize the touch path event as a tickle gesture when it determines that the touch path event traces approximately linear strokes, the length of all strokes is less than 1 cm in each direction, and the path reverses directions at least five times. Instead of counting direction reversals the processor 103 may count the number of strokes.

Optionally, before determining whether a touch path event is a tickle gesture, the processor 103 may be configured to determine whether the number of direction reversals “n” (or strokes or other parameters) is performed within a predetermined time span “t” in optional decision block 419. If the number of direction reversals “n” are not performed within the predetermined time limit “t” (i.e., optional decision block 419=“No”), the processor 103 may perform the normal GUI functions at block 410. If the number of direction reversals “n” are performed within the time limit “t” (i.e., optional decision block 419=“Yes”), the processor 103 may activate the function linked with the tickle gesture, such as activating a search function at block 420 or opening an application at block 421. Alternatively, the optional decision block 419 may be implemented as a time-out test that terminates evaluation of the touch path as a tickle gesture (i.e., determines that the traced path is not a tickle gesture) as soon as the time since the new touch event (i.e., when decision block 402=“Yes”) equals the predetermined time limit “t,” regardless of whether the number of strokes or direction reversals equals the predetermined minimum associated with the tickle gesture.

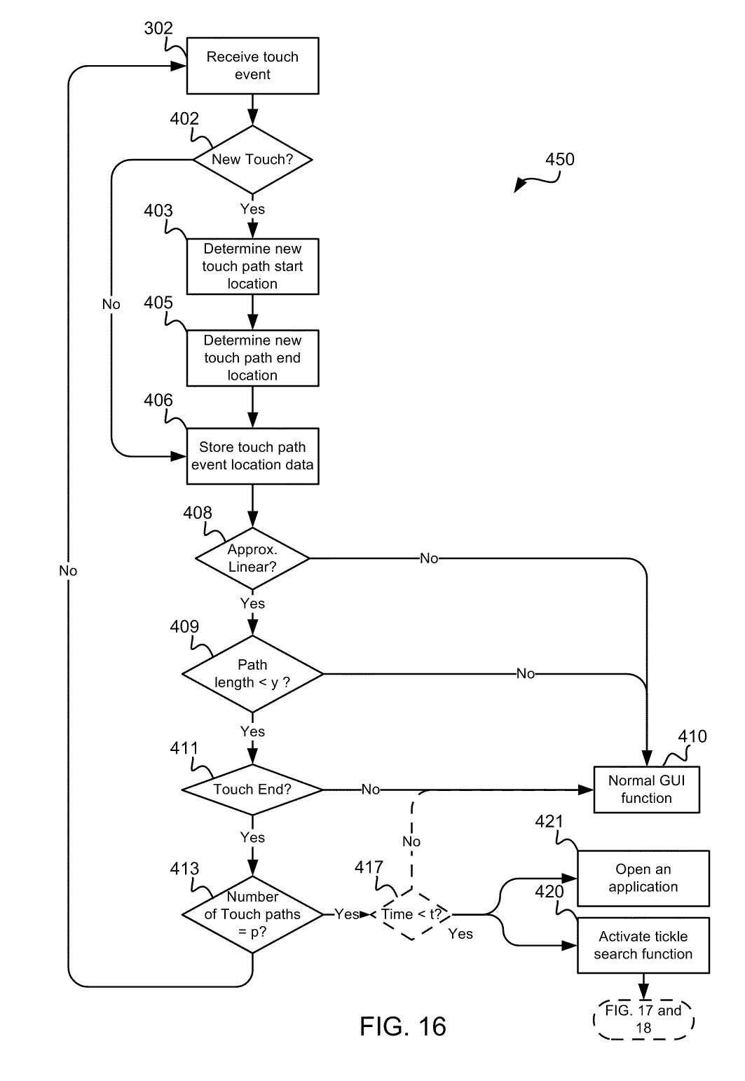

FIG. 16 illustrates a process 450 for detecting discontinuous tickle gesture touch events, e.g., a series of down-lift-down strokes. In process 450 at block 302, the processor 103 may be programmed to receive touch path events, and determine whether each touch path event is a new touch, decision block 402. If the touch path event is from a new touch (i.e. decision block 402=“Yes”), the processor 103 may determine the touch path event start location on the touchscreen display 102 at block 403, and the touch path event end location at block 405, and store the touch path event start and end location data at block 406. If the touch path event is not from a new touch (i.e., decision block 402=“No”), the processor continues to store the location of the current touch path event at block 406.

In process 450 at decision block 408, the processor 103 may determine whether the touch path event that is being traced by the user on the touchscreen display 102 follows an approximately linear path. If the touch path event being traced by the user is determined not to follow an approximately linear path (i.e., decision block 408=“No”), the processor 103 may resume normal GUI functions associated with the path being traced at block 410. If the touch path event being traced by the user is determined to follow an approximately linear path (i.e., decision block 408=“Yes”), the processor 103 may determine the length of the path being traced by the user at decision block 409. The predetermined length “y” may be designated as the threshold length beyond which the processor 103 can exclude the traced path as a tickle gesture. Thus, if the length of the traced path is longer than the predetermined length “y” (i.e., decision block 409=“No”), the processor 103 may continue normal GUI functions at block 410. If the length of the traced path is determined to be shorter than the predetermined length “y” (i.e., decision block 409=“Yes”), the processor 103 may determine whether the touch ends at decision block 411.

If the touch event does not end (i.e., decision block 411=“No”), the processor 103 may perform normal GUI functions at block 410. If the touch ends (i.e., decision block 411=“Yes”), the processor 103 may determine whether the number of paths traced one after another in a series of paths is greater than a predetermined number “p” at decision block 413. The pre-determined number of paths traced in a series “p” is the number beyond which the processor 103 can identify the traced path as a tickle gesture. Thus, if the number of traced paths in a series is less than “p” (i.e., decision block 413=“No”), the processor 103 may continue to monitor touch events by returning to block 302 to receive a next touch event. If the number of traced paths in a series is equal to “p” (i.e., decision block 413=“Yes”), the processor 103 may determine that the path traces a tickle gesture, and activate the function linked to or associated with the tickle gesture, such as a search function at block 420, or open an application at block 421.

Optionally, if the number of traced paths are greater than “p” (i.e., decision block 413=“Yes”), the processor 103 may determine whether the time period during which the touch paths have been traced is less than a predetermined time limit “t” at decision block 417. A series of touch path events that take longer than time limit “t” to satisfy the other parameters of a tickle gesture specification may not be the tickle gesture (e.g., such as series of down-panning gestures). Thus, if the processor 103 determines that the touch path events were traced during a time period greater than “t” (i.e., decision block 417=“No”), the processor 103 may perform the normal GUI functions associated with the traced path at block 410. If the processor 103 determines that the touch path events were performed within the time limit “t” (i.e., decision block 417=“Yes”), the processor 103 may recognize the touch path events as a tickle gesture and activate the function linked to the gesture, such as activating a search functionality at block 420, or open an application at block 421.

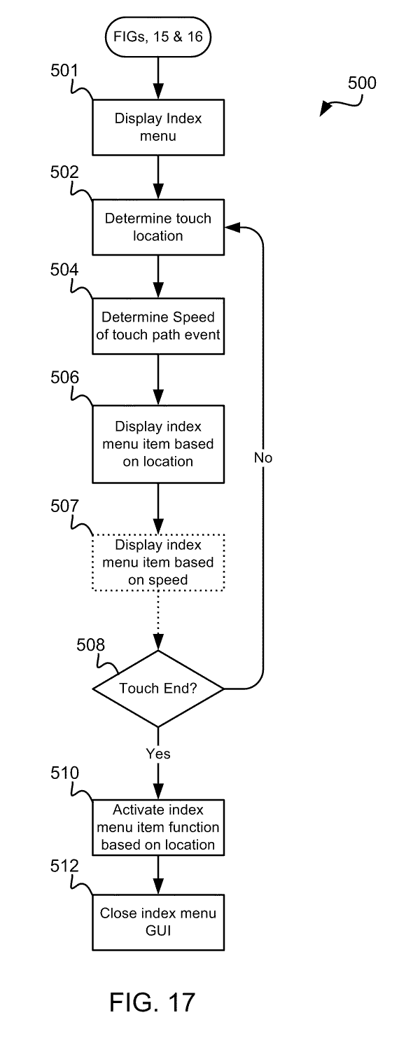

FIG. 17 shows a process 500 for generating a menu for searching a database once a tickle gesture is recognized in block 420 (FIGS. 15 and 16). In process 500 at block 501, once the menu function is activated, the processor may generate an index menu 112 for presentation on the display 104. As part of generating the index menu 112 the processor 103 may determine the location of the touch of the user's finger 108 on the touchscreen at block 502. The processor 103 may also determine the speed at which the touch path event is being traced by the user's finger 108 at block 504. At block 506 the processor may generate a display including an index menu 112 item in a menu tab 112a, for example, based on the location of the touch path event. Optionally, at block 507 the processor may take into account the speed of the touch path event in displaying index menu 112 items. For example, the index menu 112 items may be abbreviated when the touch path event is traced in a high speed, and may include more details when the touch path event is traced at a slower speed. At decision block 508 the processor 103 may determine whether the user's touch ends (i.e., the user's finger is no longer in contact with the touch surface). If the processor determines that the user touch has ended (i.e., decision block 508=“Yes”), the processor 103 may display information related to the current index menu 112 item at block 510, and close the index menu 112 graphical user interface at block 512.

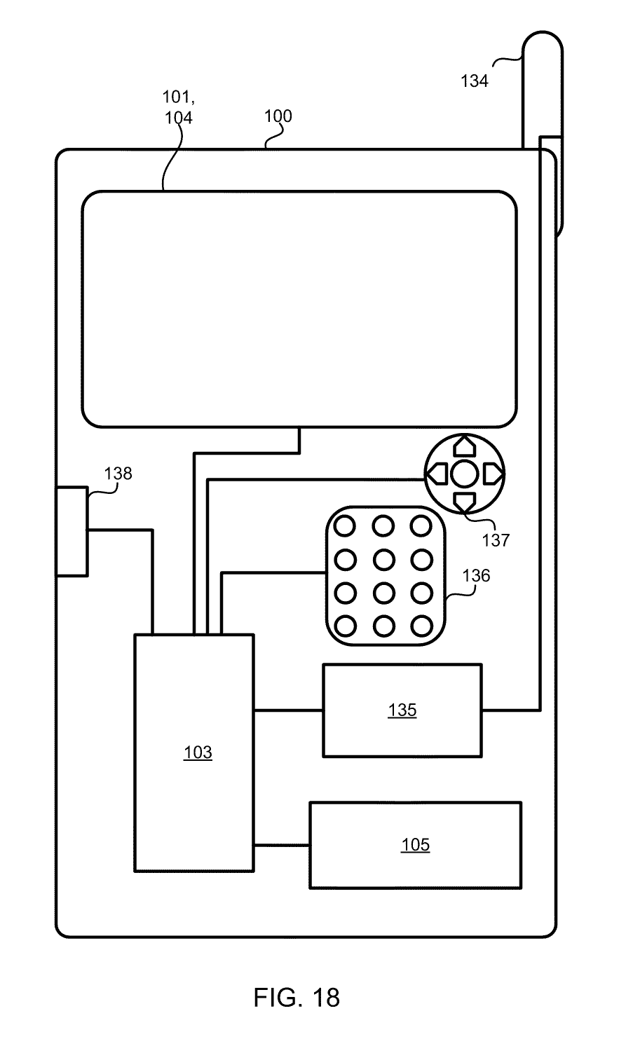

The aspects described above may be implemented on any of a variety of portable computing devices 100. Typically, such portable computing devices 100 will have in common the components illustrated in FIG. 18. For example, the portable computing devices 100 may include a processor 103 coupled to internal memory 105 and a touch surface input device 101 or display 104. The touch surface input device 101 can be any type of touchscreen display 102, such as a resistive-sensing touchscreen, capacitive-sensing touchscreen, infrared sensing touchscreen, acoustic/piezoelectric sensing touchscreen, or the like. The various aspects are not limited to any particular type of touchscreen display 102 or touchpad technology. Additionally, the portable computing device 100 may have an antenna 134 for sending and receiving electromagnetic radiation that is connected to a wireless data link and/or cellular telephone transceiver 135 coupled to the processor 103. Portable computing devices 100 which do not include a touchscreen input device 102 (typically including a display 104) typically include a key pad 136 or miniature keyboard, and menu selection keys or rocker switches 137 which serve as pointing devices. The processor 103 may further be connected to a wired network interface 138, such as a universal serial bus (USB) or FireWire connector socket, for connecting the processor 103 to an external touchpad or touch surfaces, or external local area network.

In some implementations, a touch surface can be provided in areas of the electronic device 100 outside of the touchscreen display 102 or display 104. For example, the keypad 136 can include a touch surface with buried capacitive touch sensors. In other implementations, the keypad 136 may be eliminated so the touchscreen display 102 provides the complete GUI. In yet further implementations, a touch surface may be an external touchpad that can be connected to the electronic device 100 by means of a cable to a cable connector 138, or a wireless transceiver (e.g., transceiver 135) coupled to the processor 103.

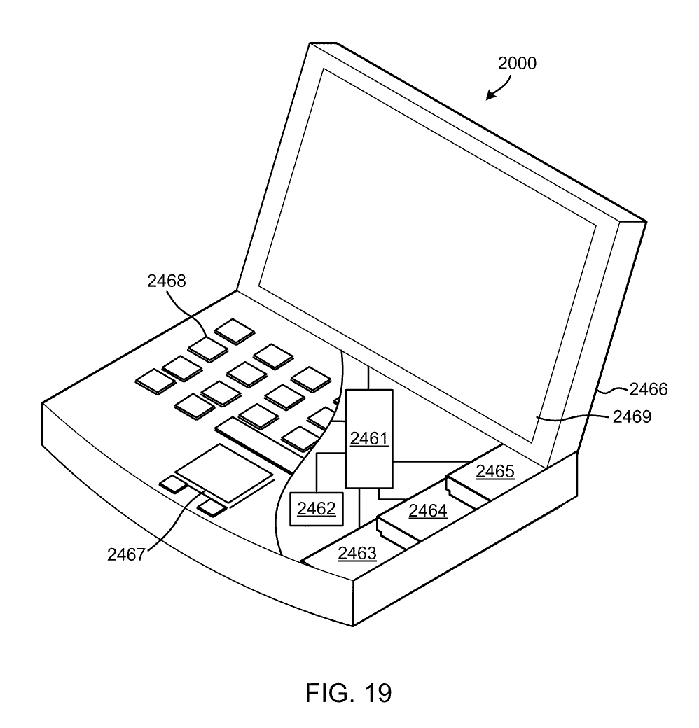

A number of the aspects described above may also be implemented with any of a variety of computing devices, such as a notebook computer 2000 illustrated in FIG. 19. Such a notebook computer 2000 typically includes a housing 2466 that contains a processor 2461 coupled to volatile memory 2462 and to a large capacity nonvolatile memory, such as a disk drive 2463. The computer 2000 may also include a floppy disc drive 2464 and a compact disc (CD) drive 2465 coupled to the processor 2461. The computer housing 2466 typically also includes a touchpad 2467, keyboard 2468, and the display 2469.

The computing device processor 103, 2461 may be any programmable microprocessor, microcomputer or multiple processor chip or chips that can be configured by software instructions (applications) to perform a variety of functions, including the functions of the various aspects described above. In some portable computing devices 100, 2000 multiple processors 103, 2461 may be provided, such as one processor dedicated to wireless communication functions and one processor dedicated to running other applications. The processor may also be included as part of a communication chipset.

The various aspects may be implemented by a computer processor 401, 461, 481 executing software instructions configured to implement one or more of the described methods or processes. Such software instructions may be stored in memory 105, 2462 in hard disc memory 2463, on tangible storage medium or on servers accessible via a network (not shown) as separate applications, or as compiled software implementing an aspect method or process. Further, the software instructions may be stored on any form of tangible processor-readable memory, including: a random access memory 105, 2462, hard disc memory 2463, a floppy disk (readable in a floppy disc drive 2464), a compact disc (readable in a CD drive 2465), electrically erasable/programmable read only memory (EEPROM), read only memory (such as FLASH memory), and/or a memory module (not shown) plugged into the computing device 5, 6, 7, such as an external memory chip or USB-connectable external memory (e.g., a “flash drive”) plugged into a USB network port. For the purposes of this description, the term memory refers to all memory accessible by the processor 103, 2461 including memory within the processor 103, 2461 itself.

The foregoing method descriptions and the process flow diagrams are provided merely as illustrative examples and are not intended to require or imply that the processes of the various aspects must be performed in the order presented. As will be appreciated by one of skill in the art the order of blocks and processes in the foregoing aspects may be performed in any order. Words such as “thereafter,” “then,” “next,” etc. are not intended to limit the order of the processes; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm processes described in connection with the aspects disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some processes or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The processes of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions stored on a machine readable medium and/or computer-readable medium, which may be incorporated into a computer program product.

The foregoing description of the various aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein, and instead the claims should be accorded the widest scope consistent with the principles and novel features disclosed herein.

What is claimed is:

1. A method for providing a user interface gesture function on a computing device, comprising:
detecting a touch path event on a user interface device;
determining whether the touch path event is a tickle gesture; and
activating a function associated with the tickle gesture when it is determined that the touch path event is the tickle gesture.

2. The method of claim 1, wherein determining whether the touch path event is a tickle gesture comprises:
determining that the touch path event traces an approximately linear path;
detecting a reversal in direction of the touch path event;
determining a length of the touch path event in each direction; and
determining a number of times the direction of the touch path event reverses.

3. The method of claim 2, wherein detecting a reversal in the direction of the touch path event comprises:
detecting whether a current direction of the touch path event is between approximately 160° and approximately 200° of a previous path direction within the touch path event.

4. The method of claim 2, further comprising:
comparing the length of the touch path event in each direction to a predefined length.

5. The method of claim 2, further comprising:
comparing the number of times the direction of the touch path event reverses to a predefined number.

6. The method of claim 2, wherein determining the length of the touch path event in each direction comprises:
detecting an end of the touch path event.

7. The method of claim 1, wherein activating a function associated with the tickle gesture comprises:
activating a menu function including a menu selection item; and
displaying the menu selection item.

8. The method of claim 7, further comprising:
determining a location of the touch path event in the user interface display;
displaying the menu selection item based on the determined touch path event location;
determining when the touch path event is ended; and
activating the menu selection item associated with the determined touch path event location when it is determined that the touch path event is ended.

9. The method of claim 7, further comprising:
determining a location of the touch path event in the user interface display;
detecting a motion associated with the touch path event;
displaying the menu selection items based on the determined touch path event motion and location;
determining when the touch path event is ended; and
activating the menu selection item associated with the determined touch path event location when it is determined that the touch path event is ended.

10. A computing device, comprising:
a processor;
a user interface pointing device coupled to the processor;
a memory coupled to the processor; and
a display coupled to the processor,
wherein the processor is configured to perform processes comprising:
detecting a touch path event on a user interface device;
determining whether the touch path event is a tickle gesture; and
activating a function associated with the tickle gesture when it is determined that the touch path event is the tickle gesture.

11. The computing device of claim 10, wherein the processor is configured to perform processes such that determining whether the touch path event is a tickle gesture comprises:
determining that the touch path event traces an approximately linear path;
detecting a reversal in direction of the touch path event;
determining a length of the touch path event in each direction; and
determining a number of times the direction of the touch path event reverses.

12. The computing device of claim 11, wherein the processor is configured to perform processes such that detecting a reversal in the direction of the touch path event comprises:
detecting whether a current direction of the touch path event is between approximately 160° and approximately 200° of a previous path direction within the touch path event.

13. The computing device of claim 11, wherein the processor is configured to perform further processes comprising:
comparing the length of the touch path event in each direction to a predefined length.

14. The computing device of claim 11, wherein the processor is configured to perform further processes comprising:
comparing the number of times the direction of the touch path event reverses to a predefined number.

15. The computing device of 11, wherein the processor is configured to perform processes such that determining the length of the touch path event in each direction comprises:
detecting an end of the touch path event.

16. The computing device of claim 10, wherein the processor is configured to perform processes such that activating a function associated with the tickle gesture comprises:
activating a menu function including a menu selection item; and
displaying the menu selection item.

17. The computing device of claim 16, wherein the processor is configured to perform further processes comprising:
determining a location of the touch path event in the user interface display;
displaying the menu selection item based on the determined touch path event location;
determining when the touch path event is ended; and
activating the menu selection item associated with the determined touch path event location when it is determined that the touch path event is ended.

18. The computing device of claim 16, wherein the processor is configured to perform further processes comprising:
determining a location of the touch path event in the user interface display;
detecting a motion associated with the touch path event;
displaying the menu selection items based on the determined touch path event motion and location;
determining when the touch path event is ended; and
activating the menu selection item associated with the determined touch path event location when it is determined that the touch path event is ended.

19. A computing device, comprising:
means for detecting a touch path event on a user interface device;
means for determining whether the touch path event is a tickle gesture; and
means for activating a function associated with the tickle gesture when it is determined that the touch path event is the tickle gesture.

20. The method of claim 19, further comprising:
means for determining that the touch path event traces an approximately linear path;
means for detecting a reversal in direction of the touch path event;
means for determining a length of the touch path event in each direction; and
means for determining a number of times the direction of the touch path event reverses.

21. The computing device of claim 20, wherein means for detecting a reversal in direction of the touch path event comprises means for detecting whether a current direction of the touch path event is between approximately 160° and approximately 200° of a previous path direction within the touch path event.

22. The computing device of claim 20, further comprising:
means for comparing the length of the touch path event in each direction to a predefined length.

23. The computing device of claim 20, further comprising:
means for comparing the number of times the direction of the touch path event reverses to a predefined number.

24. The computing device claim 20, wherein means for determining the length of the touch path event in each direction comprises:
means for detecting an end of the touch path event.

25. The computing device of claim 19, wherein means for activating a function associated with the tickle gesture comprises:
means for activating a menu function including a menu selection item; and
means for displaying the menu selection item.

26. The computing device of claim 25, further comprising:
means for determining a location of the touch path event in the user interface display;
means for displaying the menu selection item based on the determined touch path event location;
means for determining when the touch path event is ended; and
means for activating the menu selection item associated with the determined touch path event location when it is determined that the touch path event is ended.

27. The computing device of claim 25, further comprising:
means for determining a location of the touch path event in the user interface display;
means for detecting a motion associated with the touch path event;
means for displaying the menu selection items based on the determined touch path event motion and location;
means for determining when the touch path event is ended; and
means for activating the menu selection item associated with the determined touch path event location when it is determined that the touch path event is ended.

28. A computer program product, comprising:
a computer-readable medium, comprising:
at least one instruction for detecting a touch path event on a user interface device;
at least one instruction for determining whether the touch path event is a tickle gesture; and
at least one instruction for activating a function associated with the tickle gesture when it is determined that the touch path event is a tickle gesture.

29. The computer program product of claim 28, wherein the computer-readable medium further comprises:
at least one instruction for determining that the touch path event traces an approximately linear path;
at least one instruction for detecting a reversal in direction of the touch path event;
at least one instruction for determining the length of the touch path event in each direction; and
at least one instruction for determining the number of times the direction of the touch path event reverses.

30. The computer program product of claim 29, wherein the at least one instruction for detecting a reversal in the direction of the touch path event comprises:
at least one instruction for detecting whether a current direction of the touch path event is between approximately 160° and approximately 200° of a previous path direction within the touch path event.

31. The computer program product of claim 29, wherein the computer-readable medium further comprises:
at least one instruction for comparing the length of the touch path event in each direction to a predefined length.

32. The computer program product of claim 29, wherein the computer-readable medium further comprises:
at least one instruction for comparing the number of times the direction of the touch path event reversals to a predefined number.

33. The computer program product of claim 29, wherein at least one instruction for determining the length of the touch path event in each direction comprises:
at least one instruction for detecting an end of the touch path event.

34. The computer program product of claim 28, wherein at least one instruction activating a function associated with the tickle gesture comprises:
at least one instruction for activating a menu function including a menu selection item; and
at least one instruction for displaying the menu selection item.

35. The computer program product of claim 34, wherein the computer-readable medium further comprises:
at least one instruction for determining a location of the touch path event in the user interface display;
at least one instruction for displaying the menu selection item based on the determined touch path event location;
at least one instruction for determining when the touch path event is ended; and
at least one instruction for activating the menu selection item associated with the determined touch path event location when it is determined that the touch path event is ended.

36. The computer program product of claim 34, wherein the computer-readable medium further comprises:
at least one instruction for determining a location of the touch path event in the user interface display;
at least one instruction for detecting a motion associated with the touch path event;
at least one instruction for displaying the menu selection items based on the determined touch path event motion and location;
at least one instruction for determining when the touch path event is ended; and
at least one instruction for activating the menu selection item associated with the determined touch path event location when it is determined that the touch path event is ended.
